(19) United States
(12) Patent Application Publication
(10) Pub. No.: US 2013/0154343 A1
(43) Pub. Date: Jun. 20, 2013

(54) METHOD FOR OPERATING A REGENERATIVE BRAKING SYSTEM OF A VEHICLE AND CONTROL UNIT FOR A REGENERATIVE BRAKING SYSTEM

(71) Applicants: Michael KUNZ, Steinheim An Der Murr (DE); Stefan STENGERT, Stuttgart (DE)

(72) Inventors: Michael KUNZ, Steinheim An Der Murr (DE); Stefan STENGERT, Stuttgart (DE)

(21) Appl. No.: 13/716,414

(22) Filed: Dec. 17, 2012

(30) Foreign Application Priority Data
Dec. 19, 2011 (DE) 10 2011 088 942.6

(51) Int. Cl. B60T 13/58

(52) U.S. Cl. CPC B60T 13/586
USPC 303/3; 701/70

(57) ABSTRACT

A method for operating a regenerative braking system includes increasing a generator braking torque and establishing a setpoint variable with regard to a brake fluid volume to be shifted from a brake master cylinder and/or at least one brake circuit to at least one storage volume, taking into account the increased generator braking torque and a predefined hydraulic efficiency characteristic curve; reducing the generator braking torque and transferring the actual brake fluid volume previously transferred to the at least one storage volume at least partially from the at least one storage volume to the at least one brake circuit; ascertaining at least one reaction variable with regard to a hydraulic reaction of the braking system; and reestablishing the hydraulic efficiency characteristic curve of the braking system, at least taking into account the at least one ascertained reaction variable. A control unit for a regenerative braking system is also described.

### CROSS REFERENCE TO RELATED APPLICATION

The present application claims priority to Application No. DE 10 2011 088 942.6, filed in the Federal Republic of Germany on Dec. 19, 2011, which is incorporated herein in its entirety by reference thereto.

### FIELD OF INVENTION

The present invention relates to a method for operating a regenerative braking system of a vehicle. The present invention also relates to a control unit for a regenerative braking system and a regenerative braking system.

### BACKGROUND INFORMATION

A method and a device for controlling a braking system of a motor vehicle having an electric drive and two brake circuits are described in German Application No. DE 196 04 134 A1. When the vehicle is braked using the electric drive for the simultaneous charging of a battery, the hydraulic braking torque, which is applied to at least one wheel by the wheel brake cylinders of the two brake circuits, is to be reduced/deactivated despite an operation of the brake pedal. For this purpose, the pressure medium shifted from the brake master cylinder to the wheel brake cylinders due to the operation of the brake pedal is to be counteracted by transferring the pressure medium shifted from the brake master cylinder to the storage chambers of the two brake circuits by opening the outlet valves of the two brake circuits. In this way, a regenerative braking action carried out by the electric drive should be blendable.

### SUMMARY

The present invention provides a method for operating a regenerative braking system of a vehicle, a control unit for a regenerative braking system, and a regenerative braking system.

The present invention ensures a comparably simply implementable compensation of changes in the hydraulic efficiency characteristic curve of the braking system, in particular of changes in a pressure/volume characteristic of the braking system. For this purpose, the hydraulic efficiency characteristic curve of the braking system, which is a pressure/volume characteristic curve, for example, may be reliably adapted to the aging phenomena and/or a changed (increased or reduced) air gap, by being reestablished. Due to the implementable reliable reestablishment of the hydraulic efficiency characteristic curve of the braking system, it is possible to stop/prevent errors, in particular when blending a generator braking torque of the generator of the braking system with the aid of a hydraulic braking torque of the at least one wheel brake caliper of the braking system. Deceleration fluctuations which traditionally occur sometimes due to such errors are reliably preventable with the aid of the present invention.

The present invention thus ensures an improved braking comfort for a user of a regenerative braking system. Since the reestablishment of the hydraulic efficiency characteristic curve of the braking system may be carried out simply and reliably, an overall vehicle deceleration predefined by the driver may be reliably complied with despite a change over time of a generator braking torque of the generator of the braking system. For this purpose, the hydraulic braking torque of the at least one wheel brake caliper of the braking system may be adapted by transferring the brake fluid between the at least one brake circuit and the at least one storage volume in such a way that it is possible to keep the overall vehicle deceleration predefined by the driver (almost) constant even in the case of a relatively great change over time of the generator braking torque. In particular, this allows the generator to be used often enough for a sufficiently high regenerative efficiency for rapidly charging a vehicle battery to be cost-effectively achievable. The regenerative efficiency may additionally be increased since the present invention assists the driver with the modulation task in the case of a necessary substitution of the generator braking torque, e.g., due to an already charged vehicle battery and/or a vehicle speed below a minimum speed needed for generator use. Thus, the driver does not have to substitute a missing generator braking torque with an increased driver braking force by dynamically operating the brake operating element. This allows the previously customary delimitation of the generator braking torque to a maximum value, which the driver is still able to substitute by dynamically operating the brake operating element, to be dispensed with.

In one advantageous exemplary embodiment, the actual brake fluid volume corresponding to the established setpoint variable is transferred from the brake master cylinder and/or the at least one brake circuit to at least one plunger as the at least one storage volume. A component which is cost-effective and requires comparably little installation space may be used for blending the generator braking torque.

In another advantageous exemplary embodiment, the actual brake fluid volume corresponding to the established setpoint variable is shifted from the brake master cylinder and/or the at least one brake circuit to at least one storage chamber as the at least one storage volume by opening at least one valve of the at least one brake circuit at least temporarily. Moreover, it is possible to pump the actual brake fluid volume at least partially out of the at least one storage chamber as the at least one storage volume with the aid of at least one pump of the at least one brake circuit. In this way, rapidly and reliably accomplishable blending of the generator braking torque, which varies over time, is possible.

For example, at least one wheel outlet valve of the at least one brake circuit may be opened at least temporarily as the at least one valve. To carry out the method described here, a component which is usually already present in a brake circuit may thus be used.

Likewise, at least one high-pressure switching valve of the at least one brake circuit may be opened as the at least one valve. By using the at least one high-pressure switching valve, which is traditionally already present in a braking system, for blending the generator braking torque, which varies over time, comparably little installation space and relatively low manufacturing costs of a braking system operated with the aid of the method may be ensured.

In one advantageous refinement, the at least one ascertained reaction variable with regard to the hydraulic reaction of the braking system to the actual brake fluid volume transferred at least partially from the at least one storage volume to the at least one brake circuit is compared to at least one predefined minimum variable. If the at least one ascertained reaction variable exceeds the at least one predefined minimum variable, the transfer of the actual brake fluid volume, previously transferred to the at least one storage volume, from the at least one storage volume to the at least one brake circuit is terminated despite a residual volume still present in the at least one storage volume. In this way, it is preventable that an excessively high pressure is built up in the at least one brake circuit as a result of the complete transfer of the actual brake fluid volume from the at least one storage volume to the at least one brake circuit. Even in the case of a suddenly occurring change in the pressure/volume characteristic curve of the braking system, the build-up of an excessively high brake pressure in the at least one wheel brake caliper is thus preventable during blending of the generator braking torque, which decreases over time.

Additionally, the actual brake fluid volume previously transferred to the at least one storage volume may be completely transferred from the at least one storage volume to the at least one brake circuit. In this case, an additional brake fluid volume is transferred from the brake master cylinder and/or the brake fluid reservoir to the at least one brake circuit if the at least one ascertained reaction variable is below the at least one predefined minimum variable after the transfer of the actual brake fluid volume to the at least one brake circuit. In this way, even in the case of a suddenly occurring change in the pressure/volume characteristic curve of the braking system, which has the effect that, even after a complete transfer of the actual brake fluid volume, a desirable brake pressure is not yet present in the at least one wheel brake caliper, a higher hydraulic braking torque of the at least one wheel brake caliper is set due to the transferred additional brake fluid volume. Thus, a generator braking torque decreasing over time may also be reliably compensated for in this situation by transferring the actual brake fluid volume and the additional brake fluid volume.

For example, the additional brake fluid volume may be shifted from the brake master cylinder to the at least one brake circuit via at least one open high-pressure switching valve of the at least one brake circuit. In this way, a component which is often already present in a braking system may also be used for transferring the additional brake fluid volume.

The hydraulic efficiency characteristic curve of the braking system preferably includes/is a pressure/volume characteristic curve of the braking system. It is, however, pointed out that the reestablishable hydraulic efficiency characteristic curve is not limited to a pressure/volume characteristic curve.

In another advantageous exemplary refinement, the following steps may be carried out according to at least one acceleration process: carrying out a purely hydraulic braking action with the aid of the regenerative braking system, the generator braking torque being kept equal to zero despite an operation of a brake operating element situated on the brake master cylinder and only a hydraulic braking torque being applied to the at least one wheel of the vehicle with the aid of at least one wheel brake caliper of the braking system; ascertaining at least one brake operating intensity variable with regard to a brake operating intensity of the operation of the brake operating element and at least one pressure build-up variable with regard to a hydraulic reaction of the braking system to the operation of the brake operating element; and reestablishing the hydraulic efficiency characteristic curve of the braking system, at least taking into account the at least one ascertained pressure build-up variable with regard to the hydraulic reaction of the braking system to the operation of the brake operating element. A purely hydraulic braking action of the vehicle may thus also be used to reestablish the hydraulic efficiency characteristic curve of the braking system. In this way, it may be ensured that, even prior to establishing the setpoint variable with regard to the brake fluid volume to be shifted from at least one brake circuit of the braking system to at least one storage volume of the braking system, a hydraulic efficiency characteristic curve of the braking system is present which was established a comparably short amount of time before that, and is thus very likely to be accurate.

The advantages described in the previous paragraphs are also ensured in an appropriate control unit for a regenerative braking system.

These advantages are also implementable with the aid of a regenerative braking system using a corresponding control unit.

Additional features and advantages of exemplary embodiments of the present invention are explained in the following with reference to the accompanying drawings.

### BRIEF DESCRIPTION OF THE DRAWINGS

FIG. 1 shows a flow chart to illustrate an exemplary embodiment of the method for operating a regenerative braking system of a vehicle.

FIG. 2 shows a schematic representation of a regenerative braking system to explain an exemplary embodiment of the control unit.

### DETAILED DESCRIPTION

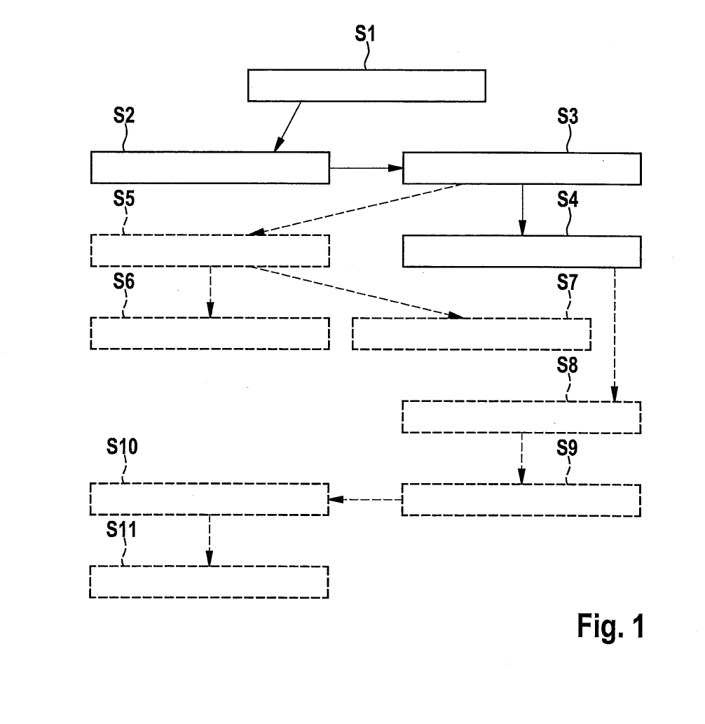

FIG. 1 shows a flow chart to illustrate an exemplary embodiment of the method for operating a regenerative braking system of a vehicle.

In a method step S1, a generator braking torque of a generator of the (regenerative) braking system which is applied to at least one wheel of the vehicle equipped with the braking system is increased by a differential variable which is not equal to zero. Prior to, during, or after increasing the generator braking torque, a setpoint variable with regard to a brake fluid volume to be shifted from a brake master cylinder of the braking system and/or from at least one brake circuit of the braking system to at least one storage volume of the braking system is also established in method step S1. The setpoint variable is established taking into account the differential variable with regard to the increased generator braking torque and a predefined hydraulic efficiency characteristic curve of the braking system. In method step S1, an actual brake fluid volume corresponding to the established setpoint variable is subsequently transferred from the brake master cylinder and/or the at least one brake circuit to the at least one storage volume.

The transfer of the actual brake fluid volume from brake master cylinder and/or the at least one brake circuit to the at least one storage volume ensures the advantage that the volume shifted by the driver of the vehicle from the brake master cylinder by the operation of a brake operating element, such as a brake pedal, does not result in an increase in the brake pressure in the at least one wheel brake caliper. In particular, this makes it possible to (completely) stop a hydraulic braking torque from building up despite the operation of the brake operating element by the driver and to carry out the braking intention of the driver with the aid of the generator braking torque.

The actual brake fluid volume corresponding to the established setpoint variable may, for example, be transferred from the brake master cylinder and/or the at least one brake circuit to at least one plunger as the at least one storage volume. Preferably, the actual brake fluid volume corresponding to the established setpoint variable is shifted from the brake master cylinder and/or the at least one brake circuit to at least one storage chamber as the at least one storage volume by opening at least one valve of the at least one brake circuit at least temporarily. In this case, it is thus possible to use components which are usually already present in the braking system to blend the increased generator braking torque. For example, at least one wheel outlet valve of the at least one brake circuit or at least one high-pressure switching valve of the at least one brake circuit may be opened as the at least one valve. It is thus not necessary to implement on the braking system an additional component, e.g., the above-named plunger, to carry out method step S1. It is, however, pointed out that the executability of method step S1 is not limited to the use of a wheel outlet valve or a high-pressure switching valve.

The established setpoint variable may include a volume variable, a plunger motor control variable, a setpoint opening time of the at least one valve, and/or a supply current signal to be applied to the at least one valve. The setpoint variable with regard to the brake fluid volume to be shifted is, however, not limited to the variables listed here.

The hydraulic efficiency characteristic curve of the braking system may, in particular, be/include a pressure/volume characteristic curve of the braking system. It is, however, pointed out that a differently implemented hydraulic efficiency characteristic curve, which represents a reaction of the braking system to a brake fluid volume present in the at least one brake circuit and the at least one wheel brake caliper connected thereto, such as a wheel brake caliper braking torque/volume characteristic curve, may be understood as the hydraulic efficiency characteristic curve.

In another method step S2, the generator braking torque is reduced, for example, due to the vehicle battery being fully charged and/or due to the instantaneous vehicle speed being below a minimum speed needed for generator use. Prior to, during, or after reducing the generator braking torque, the actual brake fluid volume previously transferred to the at least one storage volume is transferred at least partially from the at least one storage volume to the at least one brake circuit. This may also be paraphrased as shifting some of the compensating brake fluid volume which is smaller than or equal to the transferred actual brake fluid volume from the at least one storage volume to the at least one brake circuit. Method step S2 may be carried out, for example, by pumping the actual brake fluid volume at least partially out of the at least one storage chamber as the at least one storage volume with the aid of at least one pump of the at least one brake circuit. It is also possible to push the actual brake fluid volume at least partially, or the compensating brake fluid volume (completely), out of the at least one plunger with the aid of a plunger motor.

During or following method step S2, a method step S3 is carried out. In method step S3, at least one reaction variable is ascertained with regard to a hydraulic reaction of the braking system to the actual brake fluid volume transferred at least partially from the at least one storage volume to the at least one brake circuit, or a reaction to the (completely) transferred compensating brake fluid volume. The at least one reaction variable may, for example, be an admission pressure and/or brake pressure present in the at least one brake circuit. It is, however, pointed out that the at least one reaction variable may also be understood as a different variable than a pressure variable.

It is, however, pointed out that the blending processes described in method steps S2 and S3 may be carried out without the driver having to compensate for the generator braking torque, which varies over time, by dynamically operating the brake operating element. Instead, the hydraulic braking torque is set with the aid of method steps S2 and S3 in such a way that it is possible to reliably keep the overall braking torque (including the generator braking torque and the hydraulic braking torque), which is predefined by the driver by the operation of the brake operating element, despite the fact that the generator braking torque varies over time.

In a subsequent method step S4, the hydraulic efficiency characteristic curve of the braking system is reestablished. The hydraulic efficiency characteristic curve is reestablished by at least taking into account the at least one ascertained reaction variable with regard to the hydraulic reaction of the braking system to the actual brake fluid volume transferred at least partially from the at least one storage volume to the at least one brake circuit. Moreover, the compensating brake fluid volume may also be taken into account when reestablishing the hydraulic efficiency characteristic curve. It is also possible to take into account other variables, characteristic curves and/or values when reestablishing the hydraulic efficiency characteristic curve.

With the aid of method steps S1 through S4, the blending process and the hydraulic efficiency characteristic curve may be adapted to both slow changes and rapid changes in a behavior of the hydraulic efficiency/a hydraulic characteristic of the braking system. For example, aging effects or wear of the brake actuators may result in a slow change in the behavior of the hydraulic efficiency/hydraulic characteristic of the braking system.

(Changes in the hydraulic characteristic of the braking system due to aging or wear of the brake actuators occur slowly. They may lead to both an offset and a change in the pressure/volume characteristic curve increase.) In contrast to that, dynamic driving maneuvers, which in particular often trigger an increased or reduced air gap, quickly influence the behavior of the hydraulic efficiency/hydraulic characteristic of the braking system. If the hydraulic characteristic of a braking system changes due to dynamic driving maneuvers, this may occur from one braking action to the next. (Rapid changes in the hydraulic characteristic of the braking system are primarily caused by a changed air gap and result in an offset in the hydraulic characteristic of the braking system. Highly dynamic changes in the hydraulic characteristic increase, in particular in the hydraulic efficiency characteristic curve, are not/hardly to be expected in this case.)

A behavior of the hydraulic efficiency or a hydraulic characteristic may be understood to mean a hydraulic reaction of the braking system, such as in particular a change in brake pressure, to a between the brake master cylinder, the at least one brake circuit having at least one wheel brake caliper connected thereto and/or at least one storage volume of the braking system. For example, the behavior of the hydraulic efficiency or the hydraulic characteristic may be understood to mean a brake pressure/differential volume ratio, a brake pressure/driver braking force ratio, a brake pressure/driver brake pressure ratio, a brake pressure/driver braking distance ratio, and/or a brake pressure/rod position ratio.

Rapid and slow changes in the hydraulic characteristic of the braking system may result in the need for carrying out stronger or weaker operations of the brake operating element to achieve a defined deceleration/a certain hydraulic braking torque. With the aid of method steps S1 through S4, the adaptation of the predefined hydraulic efficiency characteristic curve, which is traditionally often difficult to implement, may be carried out simply and rapidly.

It is pointed out once again that, with the aid of method steps S1 through S4, the hydraulic efficiency characteristic curve may be updated with regard to rapid changes and with regard to slow changes in the hydraulic characteristic of the braking system. This may prevent deceleration fluctuations which traditionally often occur during a blending of a generator braking torque, in particular due to rapid changes in the hydraulic efficiency characteristic curve/the hydraulic characteristic of the braking system.

In one advantageous exemplary refinement of the method, the method may also have an optional method step S5 which may be carried out after method step S3. In method step S5, the at least one ascertained reaction variable (with regard to the hydraulic reaction of the braking system to the actual brake fluid volume transferred at least partially from the at least one storage volume to the at least one brake circuit) is compared to at least one predefined minimum variable. The at least one predefined minimum variable may, for example, be a setpoint brake pressure variable which may be established in particular by taking into account the reduction of the generator braking torque over time. Further examples of the at least one predefined minimum variable are also conceivable.

If the at least one ascertained reaction variable is above the at least one predefined minimum variable, a method step S6 is carried out. In method step S6, the (back) transfer of the actual brake fluid volume, previously transferred to the at least one storage volume, from the at least one storage volume to the at least one brake circuit is terminated despite a residual volume still present in the at least one storage volume. This may also be paraphrased as stopping the (back) transfer already for a compensating brake fluid volume which is smaller than the actual brake fluid volume previously transferred to the at least one storage volume, so that a remainder of the actual brake fluid volume remains as the residual volume in the at least one storage volume. With the aid of method step S6, it is thus possible to prevent a (back) transfer of too much brake fluid and thus a buildup of excess pressure in the at least one brake circuit and the at least one wheel brake caliper connected thereto.

For example, if it is detected in method step S5 that a predefined/preferred brake pressure/setpoint pressure for ensuring an advantageous hydraulic braking torque is already reached for a back-transferred compensating brake fluid volume, which is smaller than the actual brake fluid volume, the back-transfer may be stopped (immediately) with the aid of method step S6. This is advantageous since, in this case, it is very likely that if the (back) transfer of the actual brake fluid volume were to be continued until the transfer was complete, the overall vehicle deceleration predefined by the driver would be exceeded.

It is pointed out that with the aid of method step S6 it is possible to reliably respond even to a rapid change in the hydraulic efficiency characteristic curve in the direction of a lower volume requirement of the at least one brake circuit and the at least one wheel brake caliper connected thereto.

The residual volume still present in the at least one storage volume may be shifted to the brake fluid reservoir in a method step (not shown) which is preferably carried out after the completion of the braking action. This may be carried out by temporarily opening the at least one wheel outlet valve, by controlling the at least one plunger motor, and/or by activating the at least one pump. The processes carried out thereby are hardly/not noticeable to the driver.

If, in method step S2, the actual brake fluid volume previously transferred to the at least one storage volume is transferred completely from the at least one storage volume to the at least one brake circuit and if the at least one ascertained reaction variable is below the at least one predefined minimum variable after the transfer of the actual brake fluid volume to the at least one brake circuit, a method step S7 maybe carried out. In method step S7, an additional brake fluid volume is transferred from the brake master cylinder and/or the brake fluid reservoir to the at least one brake circuit. For example, the additional brake fluid volume is shifted from the brake master cylinder and/or the brake fluid reservoir to the at least one brake circuit and/or the at least one wheel brake caliper via at least one open high-pressure switching valve of the at least one brake circuit. In this way, the hydraulic braking torque may be sufficiently increased for blending the decreasing generator braking torque with the aid of method step S7 even after a change in the hydraulic efficiency characteristic curve in the direction of an increased volume requirement of the at least one brake circuit and the at least one wheel brake caliper connected thereto. With the aid of method step S7, the traditional problem of only the actual brake fluid volume present in the at least one storage volume often being usable when the hydraulic braking torque is increased for blending a generator braking torque decreasing over time may be solved.

In method step S5, the change in the hydraulic efficiency characteristic curve in the direction of an increased volume requirement of the at least one brake circuit and the at least one wheel brake caliper connected thereto may, for example, be reliably detected if the at least one ascertained reaction variable (to after a predefined waiting period had elapsed) remains below the at least one predefined minimum variable despite the running feedback pump/operated plunger motor; it is thus to be assumed that there is no pressure increase in the braking system. This reliably ensures the conclusion that the overall actual brake fluid volume has already been transferred back to the at least one brake circuit from the at least one storage volume. Moreover, the change in the hydraulic efficiency characteristic curve in the direction of an increased volume requirement of the at least one brake circuit and the at least one wheel brake caliper connected thereto is also reliably detectable, if an end position of the plunger is reached before the at least one ascertained reaction variable becomes greater than or equal to the at least one predefined minimum variable, and it may therefore be assumed that a desirable pressure has not yet been reached in the braking system.

By opening the high-pressure switching valve, it is ensured that the additional brake fluid volume flows to the suction side of the at least one pump (feedback pump) and thus may be shifted to increase the brake pressure present in the at least one wheel brake caliper. By opening the at least one high-pressure switching valve it is thus possible to carry out a compensation routine. Due to the compensation routine, a brake operating element, e.g., a brake pedal, may be moved. The movement of the brake operating element is, however, hardly seen by the driver as being disadvantageous since a corresponding movement of the brake operating element is usually also carried out in the case of a purely hydraulic braking action to compensate for a change in the hydraulic efficiency characteristic curve of the braking system. After reaching the desirable brake pressure, or at least an ascertained reaction variable which is equal to or greater than the at least one predefined minimum variable, the high-pressure switching valve may be closed again.

With the aid of method steps S5 through S7, it is preventable that, due to a changed hydraulic efficiency characteristic curve of the braking system, too much or too little volume is shifted between the at least one brake circuit and/or the brake master cylinder and the at least one storage volume. Deceleration fluctuations are therefore reliably prevented in the case of a change from the generator braking torque to an increased hydraulic braking torque.

In another advantageous exemplary refinement, the method may also include optional method steps S9 through S11 which are carried out after at least one acceleration process (method step S8).

In method step S9, a purely hydraulic braking action is carried out with the aid of the (regenerative) braking system. In this case, the generator braking torque is kept equal to zero despite the brake operating element situated on the brake master cylinder being operated. Only a hydraulic braking torque is applied to the at least one wheel of the vehicle with the aid of at least one wheel brake caliper of the braking system.

A method step S10 is carried out simultaneously with method step S9. In method step S10, at least one brake operating intensity variable with regard to a brake operating intensity of the operation of the brake operating element, e.g., a brake operation distance, a rod position, a braking force and/or a brake pressure, is ascertained. Moreover, at least one pressure build-up variable is ascertained with regard to a hydraulic reaction of the braking system to the operation of the brake operating element. The at least one pressure build-up variable with regard to the hydraulic reaction may, for example, be a brake master cylinder pressure, an admission pressure, a brake circuit pressure, and/or a wheel brake cylinder pressure. For example, the at least one pressure build-up variable may be equal to the at least one reaction variable ascertained in method step S3. It is, however, pointed out that neither the brake operating intensity variable nor the at least one pressure build-up variable with regard to the hydraulic reaction is limited to the examples listed here.

In method step S11, the hydraulic efficiency characteristic curve of the braking system is reestablished by taking into account the at least one ascertained pressure build-up variable with regard to the hydraulic reaction of the braking system to the operation of the brake operating element. In this way, a purely hydraulic braking action may also be used to update the hydraulic efficiency characteristic curve.

Method steps S9 through S11 may, for example, be carried out by recording the course of the pedal travel (or a comparable variable) and of the brake master cylinder during the purely hydraulic braking action. This may, in particular, take place during a braking action into the standstill. The volume shift resulting therefrom results from the mechanical parameters of the brake master cylinder and the pedal travel. By additionally taking into account the brake master cylinder pressure, the hydraulic efficiency characteristic curve may be advantageously updated. For this purpose, different adaptation algorithms of the hydraulic efficiency characteristic curve, in particular a pressure/volume characteristic curve, may be carried out. For example, the hydraulic efficiency characteristic curve may be immediately overwritten. Also, the hydraulic efficiency characteristic curve may be incrementally adapted over multiple purely hydraulic braking actions when method steps S9 trough S11 are carried out multiple times. Moreover, it is possible to dispense with the use of the generator in a targeted manner, at predefined time intervals, for example, to update the hydraulic efficiency characteristic curve with the aid of method steps S9 through S11. In this way, a higher blending frequency of the hydraulic efficiency characteristic curve is achievable.

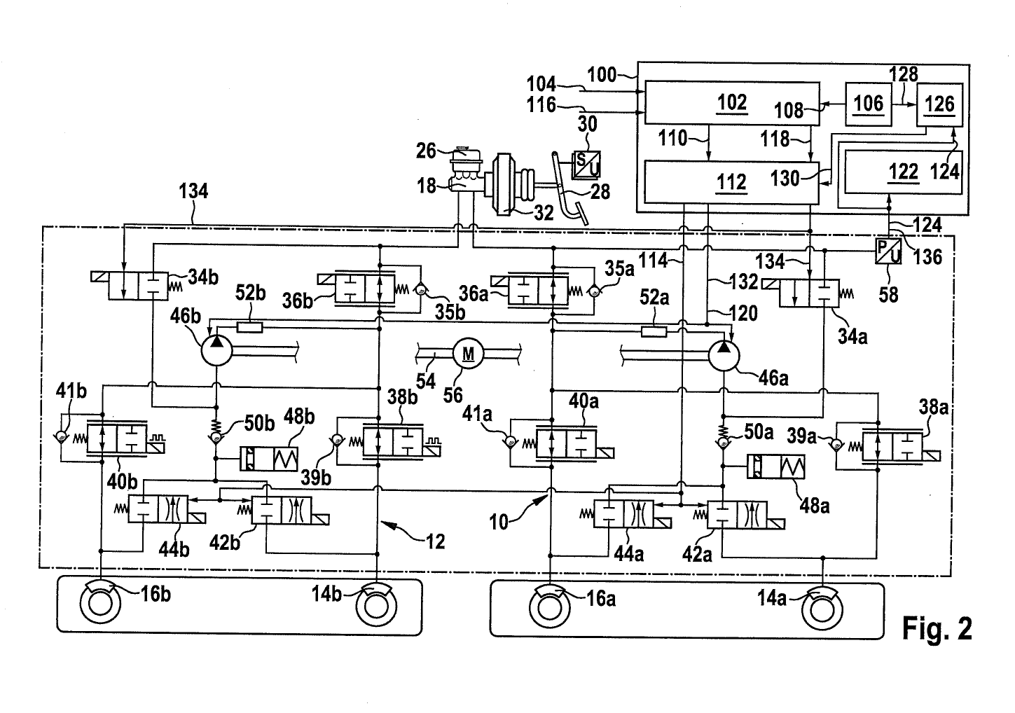

FIG. 2 shows a schematic representation of a regenerative braking system to explain an exemplary embodiment of the control unit.

The braking system represented schematically in FIG. 2 (and optionally also operable with the aid of the above-described method) is advantageously usable in a hybrid and in an electric vehicle, for example. The usability of the braking system described in the following is, however, not limited to a hybrid or an electric vehicle.

The braking system has a first brake circuit 10 having at least one wheel brake caliper 14a and 16a. Moreover, the braking system also has a second brake circuit 12 having at least one wheel brake caliper 14b and 16b. For example, the braking system includes a first brake circuit 10 having a first wheel brake caliper 14a and a second wheel brake caliper 16a, and a second brake circuit 12 having a third wheel brake caliper 14b and a fourth wheel brake caliper 16b. In this case, the braking system is preferably designed for a vehicle having a brake circuit configuration with X distribution pattern. In this case, first wheel brake caliper 14a and third wheel brake caliper 14b are assigned to a first vehicle axle, while second wheel brake caliper 16a and fourth wheel brake caliper 16b are assigned to another vehicle axle. The wheels assigned to a brake circuit 10 and 12 may be situated in particular diagonally on the vehicle. For example, first wheel brake caliper 14a and third wheel brake caliper 14b may be assigned to the front axle, while second wheel brake caliper 16a and fourth wheel brake caliper 16b may be assigned to the rear axle. The braking system described in the following is, however, not limited to a brake circuit configuration with X distribution pattern. Instead, the braking system may also be used when the wheels assigned to a joint brake circuit 10 or 12 are situated on the same axle or on one side of the vehicle.

The braking system has a brake master cylinder 18 which is implementable as a tandem brake master cylinder, for example. Brake master cylinder 18 may have at least one adjustable brake master cylinder piston which is at least partially adjustable in at least one pressure chamber of brake master cylinder 18. Brake master cylinder 18 preferably includes a first adjustable piston (primary piston) which may be referred to as a push-rod piston and which protrudes at least partially into a first pressure chamber of brake master cylinder 18 assigned to first brake circuit 10, and a second adjustable piston (secondary piston) which may be referred to as a floating piston and which protrudes at least partially into a second pressure chamber of brake master cylinder 18 assigned to second brake circuit 12. The braking system is, however, not limited to the use of a tandem brake master cylinder or to a certain design of brake master cylinder 18. Brake master cylinder 18 may be connected to a brake medium reservoir 26 via at least one brake fluid exchange opening, e.g., a compensating bore.

The braking system preferably has a brake operating element 28, e.g., a brake pedal, which is situated on brake master cylinder 18. Brake operating element 28 is advantageously situated on brake master cylinder 18 in such a way that, when brake operating element 28 is operated using at least minimum strength, a driver braking force applied to brake operating element 28 is transferrable to at least one adjustable brake master cylinder piston, e.g., to the push-rod piston and the floating piston, in such a way that the brake master cylinder piston is adjustable with the aid of the driver braking force. An internal pressure in at least one pressure chamber of brake master cylinder 18 is preferably increased with the aid of this adjustment of the brake master cylinder piston.

The braking system also preferably includes at least one brake operating element sensor 30 with the aid of which the brake operating intensity of the operation of brake operating element 28 is ascertainable by the driver. Brake operating element sensor 30 may, for example, include a braking force sensor, a brake pressure sensor, a pedal travel sensor, a differential distance sensor, and/or a rod position sensor. To detect the brake operating intensity (brake operating intensity variable), which corresponds to the braking intention of the driver, a different type of sensor system is usable, however, instead of or in addition to the sensor types listed here.

In a preferred exemplary embodiment, the illustrated braking system also has a brake booster 32, e.g., a vacuum brake booster. Instead of a vacuum brake booster, the braking system may also have another type of brake booster 32, e.g., a hydraulic and/or an electromechanical booster device. Brake booster 32 may, in particular, be a continuously adjustable/continuously controllable brake booster 32.

Other components of the braking system are described in the following with reference to FIG. 2. It is explicitly pointed out that the components of the braking system described in the following are merely examples of a possible design of a braking system operable/controllable/usable in an improved manner with the aid of the method. One advantage of the above-described method and control unit 100 described below is that brake circuits 10 and 12 are not restricted to a certain design or the use of certain components. Instead, there is a large number of modifications to choose from for brake circuits 10 and 12.

Each of brake circuits 10 and 12 is designed to have a high-pressure switching valve 34a and 34b and a switchover valve 36a and 36b (having a bypass line running in parallel thereto and a check valve 35a and 35b situated therein) in such a way that the driver may brake directly into wheel brake calipers 14a, 14b, 16a, and 16b via brake master cylinder 18. In first brake circuit 10, a first wheel inlet valve 38a is assigned to first wheel brake caliper 14a, and a second wheel inlet valve 40a is assigned to second wheel brake caliper 16a, each having a bypass line running in parallel thereto and a check valve 39a and 41a situated therein. Additionally, a first wheel outlet valve 42a is assigned to first wheel brake caliper 14a and a second wheel outlet valve 44a is assigned to second wheel brake caliper 16a. Accordingly, a third wheel inlet valve 38b may also be assigned to third wheel brake caliper 14b and a fourth wheel inlet valve 40b may be assigned to fourth wheel brake caliper 16b in second brake circuit 12. A bypass line having a check valve 39b and 41b situated therein may run in parallel to each of the two wheel inlet valves 38b and 40b of second brake circuit 12. Furthermore, a third wheel outlet valve 42b may be assigned to third wheel brake caliper 14b and a fourth wheel outlet valve 44b may be assigned to fourth wheel brake caliper 16b in second brake circuit 12.

Moreover, each of brake circuits 10 and 12 includes a pump 46a and 46b whose suction side is connected to wheel outlet valves 42a and 44a or 42b and 44b and whose discharge side is directed toward assigned switchover valve 36a or 36b. Brake circuits 10 and 12 may also have a storage chamber 48a or 48b (e.g., low-pressure storage device) situated between wheel outlet valves 42a and 44a or 42b and 44b and pump 46a or 46b, and a pressure-relief valve 50a or 50b situated between pump 46a or 46b and storage chamber 48a or 48b. Optionally, each of the two brake circuits 10 and 12 may also include a smoothing filter 52a or 52b which is situatable on a discharge side of particular pump 46a or 46b. With the aid of such a pump smoothing filter 52a and 52b, it is possible to smooth a discharge volume generated with the aid of the at least one pump 46a and 46b.

Pumps 46a and 46b may be situated on a joint shaft 54 of a motor 56. Each pump 46a and 46b may be designed as a three-piston pump. However, instead of a three-piston pump, any other type of pump may be used for at least one of pumps 46a and 46b. Differently designed modulation systems, e.g. pumps having multiple or fewer pistons, asymmetric pumps, or gear pumps, may also be used. Moreover, each of the two brake circuits 10 and 12 may also include at least one pressure sensor 58, in particular at a supply line of a first wheel brake caliper 14a and/or third wheel brake caliper 14b used as a front axle brake caliper. The braking system is thus designable as a modified standard modulation system, in particular as a six-piston ESP system.

It is pointed out again that the use of the above-described braking system with the aid of the method explained in the following is to be interpreted only as an example. The executability of the method described in the following is not limited to the use of such a braking system. In particular, equipping the above-described braking system with its listed components is to be interpreted only as an example.

The braking system is designed as a regenerative braking system having at least one generator (not illustrated). It is explained in the following how to advantageously blend a generator braking torque (not equal to zero) of the generator during a braking action.

Control unit 100 has a blending device 102 with the aid of which a first differential variable 104 with regard to an increased generator braking torque of the generator is receivable. Taking into account received first differential variable 104 and a hydraulic efficiency characteristic curve 108 of the braking system, predefined by a storage unit 106 of control unit 100, a first setpoint variable 110 with regard to a brake fluid volume to be shifted from brake master cylinder 18 and/or at least one brake circuit 10 and 12 of the braking system to at least one storage volume of the braking system is establishable with the aid of blending device 102.

Control unit 100 also has a control unit 112 with the aid of which at least one first control signal 114 corresponding to first setpoint variable 110 may be output to at least one first component of at least one brake circuit 10 and 12 in such a way that an actual brake fluid volume (corresponding to established first setpoint variable 110) is transferrable from the at least one brake circuit 10 and 12 and/or from brake master cylinder 18 to the at least one storage volume with the aid of the at least one controlled component. For example, at least one valve of the at least one brake circuit 10 and 12 may be controllable at least temporarily in an open state with the aid of the at least one first control signal 114.

The valve, which is at least temporarily controlled in a semi-open state, may be at least one wheel outlet valve 42a, 42b, 44a, and 44b of brake circuit 10 and 12. A high-pressure switching valve 34a or 34b of brake circuit 10 and 12 may likewise be controlled as the at least one valve at least temporarily in an at least semi-open state. (In this case, it is advantageous to dispense with equipping the regenerative braking system with pressure-relief valves 50a and 50b.)

As the storage volume of a brake circuit 10 and 12, particular storage chamber 48a or 48b may, for example, be used. It is, however, pointed out that each of brake circuits 10 and 12 may also have an additional storage chamber which may be used as the storage volume.

Blending device 102 is additionally designed to receive a second differential variable 116 with regard to a reduced generator braking torque of the generator. Taking into account received second differential variable 116 and predefined hydraulic efficiency characteristic curve 108, blending device 102 establishes a second setpoint variable 118 with regard to a compensating brake fluid volume to be shifted from the at least one storage volume to the at least one brake circuit. With the aid of control unit 112, at least one second control signal 120 corresponding to second setpoint variable 118 is output to the at least one first component and/or the at least one second component of the at least one brake circuit 10 and 12 in such a way that the actual brake fluid volume previously transferred to the at least one storage volume is transferrable at least partially from the at least one storage volume to the at least one brake circuit 10 and 12. In particular, the at least one pump 46a and 46b of the at least one brake circuit 10 and 12 may be activatable with the aid of the at least one second control signal 120.

Furthermore, control unit 100 has a characteristic curve establishing device 122 with the aid of which at least one reaction variable 124 with regard to a hydraulic reaction of the braking system to the actual brake fluid volume transferred at least partially from the at least one storage volume to the at least one brake circuit 10 and 12 is receivable. The at least one reaction variable 124 may, for example, be made available by sensor 58 to characteristic curve establishing device 122. At least taking into account the at least one ascertained reaction variable 124 with regard to the hydraulic reaction of the braking system to the actual brake fluid volume, transferred at least partially from the at least one storage volume to the at least one brake circuit 10 and 12, hydraulic efficiency characteristic curve 108 of the braking system is reestablishable. (Reestablished [hydraulic] efficiency characteristic curve 108 may subsequently be stored on storage unit 106.)

In one advantageous refinement, control unit 100 additionally includes a comparator 126 with the aid of which the at least one ascertained reaction variable 124 with regard to the hydraulic reaction of the braking system to the actual brake fluid volume, transferred at least partially from the at least one storage volume to the at least one brake circuit 10 and 12, is comparable to at least one predefined minimum variable 128. A differential signal 130 which corresponds to the comparison of the at least one ascertained reaction variable 124 to the at least one predefined minimum variable 128 may be output to control unit 112. In this case, control unit 112 is additionally designed to output, if the at least one ascertained reaction variable 124 is above the at least one predefined minimum variable 128, at least one third control signal 132 to the at least one first component and/or the at least one second component. This takes place in such a way that, with the aid of the at least one third control signal 132, the transfer of the actual brake fluid volume, previously transferred to the at least one storage volume, from the at least one storage volume to the at least one brake circuit 10 and 12 is terminatable despite a residual volume still present in the at least one storage volume. If after the complete transfer of the actual brake fluid volume from the at least one storage volume to the at least one brake circuit 10 and 12, the at least one ascertained reaction variable 124 is below the at least one predefined minimum variable 128, control unit 112 is designed to output at least one fourth control signal 134 to at least one third component of the at least one brake circuit 10 and 12, e.g., a high-pressure switching valve 34a and 34b. By controlling the at least one third component with the aid of the at least one fourth control signal 134, it may be ensured that an additional brake fluid volume is transferrable from the brake master cylinder and/or brake fluid reservoir 26 to the at least one brake circuit 10 and 12. This ensures the advantages described above.

In another advantageous exemplary refinement of control unit 100, characteristic curve establishing device 122 is additionally designed to receive at least one pressure build-up variable 136 with regard to a hydraulic reaction of the braking system to a brake operating intensity of an operation of a brake operating element 28 in the case of a purely hydraulic braking action and to reestablish hydraulic efficiency characteristic curve 108 of the braking system, at least taking into account the at least one ascertained pressure build-up variable 136 with regard to the hydraulic reaction of the braking system to the operation of brake operating element 28. Thus, control unit 100 may also be designed to use a purely hydraulic braking action to update hydraulic efficiency characteristic curve 108.

The above-stated advantages are also ensured for a regenerative braking system using control unit 100. It is pointed out again that equipping the regenerative braking system with the above-described components is to be interpreted only as an example. Thus, a plurality of regenerative braking systems may cooperate with control unit 100 and thus implement the above-described advantages.

What is claimed is:

1. A method for operating a regenerative braking system of a vehicle, comprising:
increasing a generator braking torque of a generator of the braking system which is applied to at least one wheel of the vehicle, and establishing a setpoint variable with regard to a brake fluid volume to be shifted from at least one of a brake master cylinder and at least one brake circuit of the braking system to at least one storage volume of the braking system, taking into account a differential variable with regard to the increased generator braking torque and a predefined hydraulic efficiency characteristic curve of the braking system, an actual brake fluid volume corresponding to the established setpoint variable being transferred from the at least one of the brake master cylinder and the at least one brake circuit to the at least one storage volume;
reducing the generator braking torque and transferring the actual brake fluid volume previously transferred to the at least one storage volume at least partially from the at least one storage volume to the at least one brake circuit;
ascertaining at least one reaction variable with regard to a hydraulic reaction of the braking system to the actual brake fluid volume transferred at least partially from the at least one storage volume to the at least one brake circuit; and
reestablishing the hydraulic efficiency characteristic curve of the braking system, at least taking into account the at least one ascertained reaction variable.

2. The method according to claim 1, wherein the actual brake fluid volume corresponding to the established setpoint variable is transferred from the at least one of the brake master cylinder and the at least one brake circuit to at least one plunger as the at least one storage volume.

3. The method according to claim 1, wherein the actual brake fluid volume corresponding to the established setpoint variable is shifted from the at least one of the brake master cylinder and the at least one brake circuit to at least one storage chamber as the at least one storage volume by opening at least one valve of the at least one brake circuit at least temporarily, and the actual brake fluid volume is pumped at least partially from the at least one storage chamber as the at least one storage volume with the aid of at least one pump of the at least one brake circuit.

4. The method according to claim 3, wherein at least one wheel outlet valve of the at least one brake circuit is opened at least temporarily as the at least one valve.

5. The method according to claim 3, wherein at least one high-pressure switching valve of the at least one brake circuit is opened as the at least one valve.

6. The method according to claim 1, wherein the at least one ascertained reaction variable with regard to the hydraulic reaction of the braking system to the actual brake fluid volume transferred at least partially from the at least one storage volume to the at least one brake circuit is compared to at least one predefined minimum variable, and
if the at least one ascertained reaction variable exceeds the at least one predefined minimum variable, the transfer of the actual brake fluid volume, previously transferred to the at least one storage volume, from the at least one storage volume to the at least one brake circuit is terminated despite a residual volume still being present in the at least one storage volume.

7. The method according to claim 6, wherein the actual brake fluid volume previously transferred to the at least one storage volume is completely transferred from the at least one storage volume to the at least one brake circuit, and, if the at least one ascertained reaction variable is below the at least one predefined minimum variable after the transfer of the actual brake fluid volume to the at least one brake circuit, an additional brake fluid volume is transferred from at least one of the brake master cylinder and a brake fluid reservoir to the at least one brake circuit.

8. The method according to claim 7, wherein the additional brake fluid volume is shifted from the at least one of the brake master cylinder and the brake fluid reservoir to the at least one brake circuit via at least one open high-pressure switching valve of the at least one brake circuit.

9. The method according to claim 1, wherein the hydraulic efficiency characteristic curve of the braking system includes a pressure/volume characteristic curve of the braking system.

10. The method according to claim 1, further comprising, after at least one acceleration process:
carrying out a purely hydraulic braking action with the aid of the regenerative braking system, the generator braking torque being kept equal to zero despite an operation of a brake operating element situated on the brake master cylinder and only a hydraulic braking torque being applied to the at least one wheel of the vehicle with the aid of at least one wheel brake caliper of the braking system;
ascertaining at least one brake operating intensity variable with regard to a brake operating intensity of the operation of the brake operating element and at least one pressure build-up variable with regard to a hydraulic reaction of the braking system to the operation of the brake operating element; and
reestablishing the hydraulic efficiency characteristic curve of the braking system, at least taking into account the at least one ascertained pressure build-up variable with regard to the hydraulic reaction of the braking system to the operation of the brake operating element.

11. A control unit for a regenerative braking system, comprising:
a blending device with the aid of which a first differential variable with regard to an increased generator braking torque of a generator of the braking system and a second differential variable with regard to a reduced generator braking torque of the generator are receivable, taking at least into account the received first differential variable and a predefined hydraulic efficiency characteristic curve of the braking system, a first setpoint variable with regard to a brake fluid volume to be shifted from at least one brake circuit of the braking system to at least one storage volume of the braking system being establishable, and taking into account the received second differential variable and the predefined hydraulic efficiency characteristic curve, a second setpoint variable with regard to a compensating brake fluid volume to be shifted from the at least one storage volume to the at least one brake circuit being establishable;
a control unit with the aid of which at least one first control signal corresponding to the first setpoint variable may be output to at least one first component of the at least one brake circuit such that an actual brake fluid volume corresponding to the established first setpoint variable is transferrable from at least one of a brake master cylinder and the at least one brake circuit to the at least one storage volume with the aid of the at least one first component, and with the aid of which at least one second control signal corresponding to the second setpoint variable may be output to at least one of the at least one first component and at least one second component of the at least one brake circuit such that the actual brake fluid volume previously transferred to the at least one storage volume is transferrable at least partially from the at least one storage volume to the at least one brake circuit; and
a characteristic curve establishing device with the aid of which at least one reaction variable with regard to a hydraulic reaction of the braking system to the actual brake fluid volume transferred at least partially from the at least one storage volume to the at least one brake circuit is receivable, and the hydraulic efficiency characteristic curve of the braking system is reestablishable by at least taking into account the at least one ascertained reaction variable with regard to the hydraulic reaction of the braking system to the actual brake fluid volume transferred at least partially from the at least one storage volume to the at least one brake circuit.

12. The control unit according to claim 11, wherein at least one valve of the at least one brake circuit is controllable at least temporarily in an open state with the aid of the at least one first control signal, and at least one pump of the at least one brake circuit is activatable with the aid of the at least one second control signal.

13. The control unit according to claim 11, further comprising:
a comparator with the aid of which the at least one ascertained reaction variable with regard to the hydraulic reaction of the braking system to the actual brake fluid volume transferred at least partially from the at least one storage volume to the at least one brake circuit is comparable to at least one predefined minimum variable, and a corresponding differential signal may be output to the control unit, the control unit being additionally configured to output, if the at least one ascertained reaction variable is above the at least one predefined minimum variable, at least one third control signal to the at least one of the at least one first component and the at least one second component such that the transfer of the actual brake fluid volume, previously transferred to the at least one storage volume, from the at least one storage volume, to the at least one brake circuit is terminatable despite a residual volume still being present in the at least one storage volume and, if after the completed transfer of the actual brake fluid volume from the at least one storage volume to the at least one brake circuit, the at least one ascertained reaction variable is below the at least one predefined minimum variable, to output at least one fourth control signal to at least one third component of the at least one brake circuit such that an additional brake fluid volume is transferrable from at least one of the brake master cylinder and a brake fluid reservoir to the at least one brake circuit.

14. The control unit according to claim 11, wherein the characteristic curve establishing device is additionally configured to receive at least one pressure build-up variable with regard to a hydraulic reaction of the braking system to a brake operating intensity of an operation of a brake operating element in the case of a purely hydraulic braking action and to reestablish the hydraulic efficiency characteristic curve of the braking system, at least taking into account the at least one ascertained pressure build-up variable with regard to the hydraulic reaction of the braking system to the operation of the brake operating element.

15. A regenerative braking system, comprising:
the control unit according to claim 11.
